(19) United States
(12) Patent Application Publication
(10) Pub. No.: US 2023/0344895 A1
(43) Pub. Date: Oct. 26, 2023

(54) SYSTEMS AND METHODS FOR DOWNLOADING FILES

(71) Applicant: Citrix Systems, Inc., Fort Lauderdale, FL (US)

(72) Inventors: Tianze Jiang, Jiangsu (CN); Sisi Chen, Jiangsu (CN)

(21) Appl. No.: 17/745,993

(22) Filed: May 17, 2022

Related U.S. Application Data
(63) Continuation of application No. PCT/CN2022/088911, filed on Apr. 25, 2022.

(51) Int. Cl. H04L 67/06; H04L 67/1074; H04L 9/40

(52) U.S. Cl. CPC H04L 67/06; H04L 67/1078; H04L 63/0263

(57) ABSTRACT

One disclosed method involves receiving, by a first application executing on a first client device, a link to download a file from a computing system, presenting, by the first application and via the first client device, a user interface element that, when selected, causes the first application to request a second application executing on a second client device to initiate a process for downloading the file from the computing system using the link, in response to detecting selection of the user interface element, sending, by the first application, a request to the second application to initiate the process, and receiving, by the first client device, the file that the second application caused download of from the computing system using the link.

### CROSS-REFERENCE TO RELATED APPLICATIONS

This application is a continuation of and claims the benefit under 35 U.S.C. § 120 and 35 U.S.C. § 365(c) to International Application PCT/CN2022/088911, entitled SYSTEMS AND METHODS FOR DOWNLOADING FILES, with an international filing date of Apr. 25, 2022, the entire contents of which are incorporated herein by reference for all purposes.

### BACKGROUND

Various file sharing systems have been developed that allow users to share files or other data. ShareFile®, offered by Citrix Systems, Inc., of Fort Lauderdale, FL, is one example of such a file sharing system.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method may involve receiving, by a first application executing on a first client device, a link to download a file from a computing system, presenting, by the first application and via the first client device, a user interface element that, when selected, causes the first application to request a second application executing on a second client device to initiate a process for downloading the file from the computing system using the link, in response to detecting selection of the user interface element, sending, by the first application, a request to the second application to initiate the process, and receiving, by the first client device, the file that the second application caused download of from the computing system using the link.

In some of the disclosed embodiments, a method may involve receiving, from a first application executing on a first client device and by a second application executing on a second client device, a link to download a file from a computing system, causing, by the second application, the file to be downloaded from the computing system, and causing, by the second application, the downloaded file to be sent to the first client device.

In some of the disclosed embodiments, a first client device may comprise at least one processor, and at least one computer-readable medium encoded with instructions which, when executed by the at least one processor, cause the first client device to receive, by a first application executing on the first client device, a link to download a file from a computing system, present, by the first application, a user interface element that, when selected, causes the first application to request a second application executing on a second client device to initiate a process for downloading the file from the computing system using the link, in response to detecting selection of the user interface element, send, by the first application, a request to the second application to initiate the process, and receive the file that the second application caused download of from the computing system using the link.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A shows an example implementation of a system in which a first client device can request a second client device to initiate downloading of a file from a computing system on its behalf, in accordance with some embodiments of the present disclosure;

FIG. 1B shows an example implementation of a system in which a second client device can initiate downloading a file from a computing system on behalf of a first client device, in accordance with some embodiments of the present disclosure;

FIG. 2 is a diagram of a network environment in which some embodiments of the novel systems and methods disclosed herein may deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5A is a diagram illustrating how a network computing environment like one shown in FIG. 2 may be configured to allow clients access to an example embodiment of a file sharing system;

FIG. 5B is a diagram illustrating certain operations that may be performed by the file sharing system shown in FIG. 5A in accordance with some embodiments;

FIG. 5C is a diagram illustrating additional operations that may be performed by the file sharing system shown in FIG. 5A in accordance with some embodiments;

FIG. 6A is a diagram illustrating example components of a first example implementation of the system shown in FIGS. 1A and 1B;

FIG. 6B is a diagram illustrating example components of a second example implementation of the system shown in FIGS. 1A and 1B;

FIGS. 7A-7F illustrate example user interface screens of an application that can be used to request download of a file from a computing system and that can be used to fulfill such request;

FIG. 8 is a flowchart of an example routine that may be performed by a first client device according to an example implementation of the system shown in FIGS. 6A and 6B; and

FIG. 9 is a flowchart of another example routine that may be performed by a second client device according to an example implementation of the system shown in FIGS. 6A and 6B.

### DETAILED DESCRIPTION

Downloading files is a common practice. Sometimes the files are stored at computing systems with which a client device has to establish a connection to download the file. In some cases, such a computing system may be accessible to the client device only via a relatively low quality connection. For example, the computing system may be located within an intranet of an organization and for some reason (e.g., if a user is working from home), the client device may be required to access the intranet via a virtual private network (VPN) connection. The inventors of the present disclosure have recognized and appreciated that downloading files from a computing system in such a scenario may be difficult based on the relatively low quality of the connection established between the computing system and the client device.

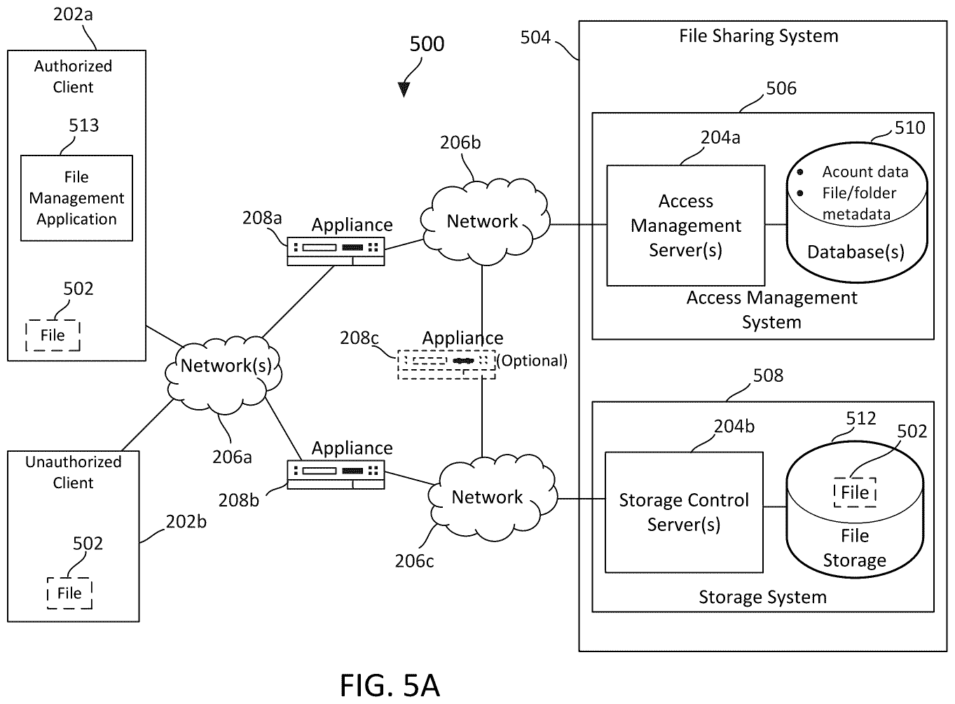

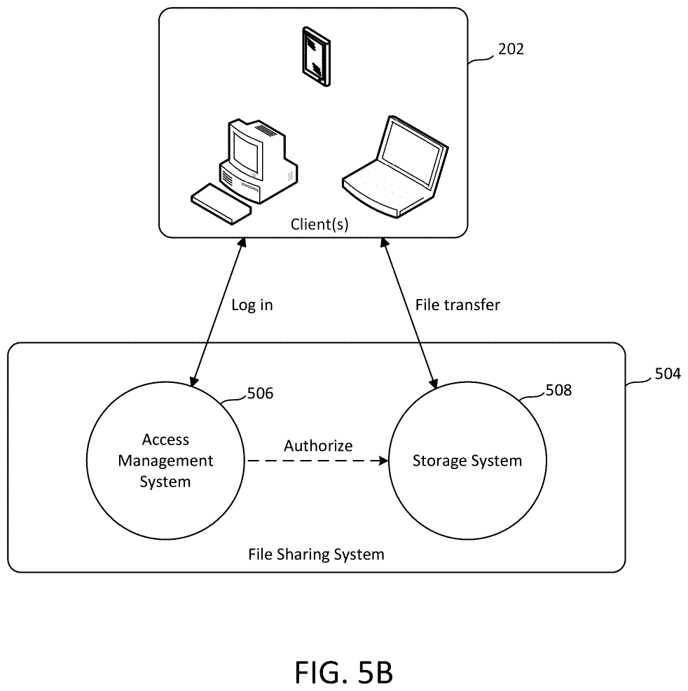

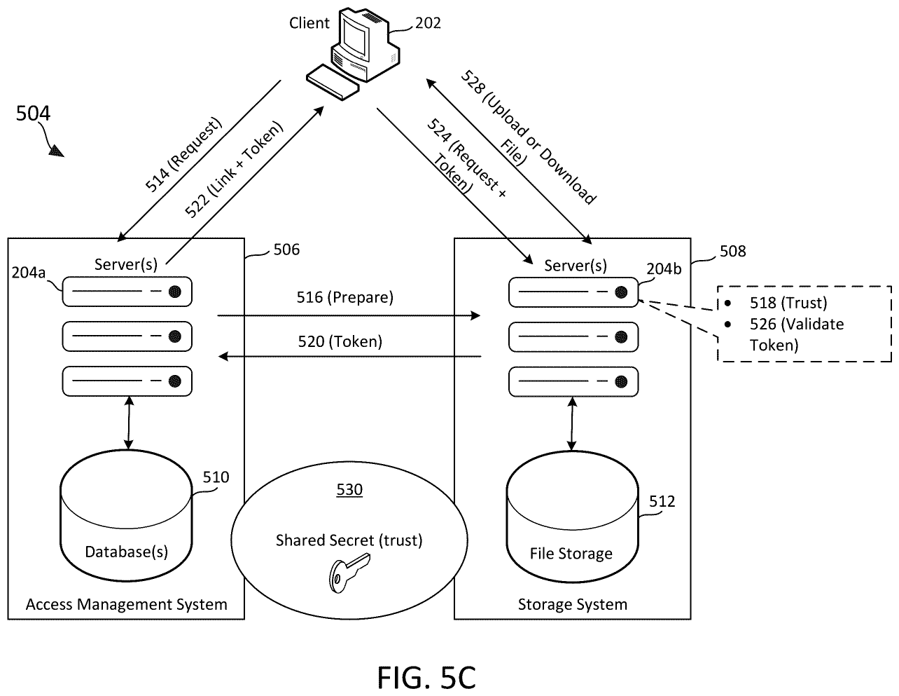

Various file sharing systems have been developed that allow users to share files with other users over a network. An example of such a file sharing system 504 is described below (in Section E) in connection with FIGS. 5A-C. As explained in Section E, in some implementations, one client device 202 may upload a file 502 (shown in FIG. 5A) to a central repository of the file sharing system 504, such as storage medium(s) 512 shown in FIGS. 5A-C, and another client device 202 may then download a copy of that file 502 from the same repository. As Section E also describes, in some implementations, an access management system 506 may regulate the circumstances in which files 502 may be uploaded and/or downloaded to/from a storage system 508 (including the storage medium 512(s)) by various client devices 202. As also described in Section E, a file can be downloaded using a link provided by the file sharing system.

Offered are techniques for a first client device to request, via an application, a second client device to download a file using a link that identifies the file on the computing system (e.g., a file sharing system or other file server). In some implementations, the first client device may be connected to the computing system via a relatively low quality connection (e.g., a VPN connection), while the second client device may be connected to the computing system via a higher quality connection.

For illustration purposes, assume a first user, operating the first client device, is working from home, and connects the first client device to an organization's internal network using a VPN connection. Further assume that the first client device (e.g., using a local Microsoft Teams application or a browser) also connects, via the public internet, to a server of a collaboration application (e.g., a Microsoft Teams server) that is outside of the organization's internal network and thus need not be accessed via the VPN connection. The first user wants to download a file from a file server deployed within the organization's internal network. But due to the relatively low quality of the VPN connection, downloading the file may be difficult. A second user may be working from the office and operating the second client device that is connected directly to the organization's internal network, rather than via a VPN connection. The second client device may also be connected to a server of the same collaboration application as the first client device (e.g., a Microsoft Teams server). Using the collaboration application (e.g., Microsoft Teams), the first user can cause the first client device to send a request to the second client device to download the desired file from the file server (e.g., using a link). Since the second client device is directly connected to the internal network, rather than via a VPN connection, the file can be downloaded easily by the second client device. The second client device can then use the collaboration application to transfer the downloaded file to the first client device. Because the first client device is connected to a server of the collaboration application via the public internet, without passing through a VPN, the file can also be easily transferred from the second client device to the first client device via the server.

In some implementations of the present disclosure, an application on the first client device (e.g., a local Microsoft Teams application or a browser executing a web-based Microsoft Teams application) may cause the first client device to present one or more user interface (UI) elements (e.g., within a UI screen of the Microsoft Teams application) that can be selected by the first user to cause the first client device to communicate the request to the second client device (e.g., via one or more Microsoft Teams servers) to download the file using a link that identifies the file on the computing system (e.g., a file server). In some implementations, in response to receiving such a request, an application on the second client device (e.g., a local Microsoft Teams application or a browser executing a web-based Microsoft Teams application) may cause the second client device to present one or more UI elements (e.g., within a UI screen of the Microsoft Teams application) that can be selected by the second user to initiate automated downloading of the file from the computing system, as well as transferring of the file to the first client device after it has been downloaded.

For purposes of reading the description below of the various embodiments, the following descriptions of the sections of the specification and their respective contents may be helpful:
Section A provides an introduction to example embodiments of a system enabling a client device to request another client device to initiate downloading a file from a computing system on its behalf;
Section B describes a network environment which may be useful for practicing embodiments described herein;
Section C describes a computing system which may be useful for practicing embodiments described herein;
Section D describes embodiments of systems and methods for accessing computing resources using a cloud computing environment;
Section E describes example embodiments of systems for providing file sharing over networks;
Section F provides a more detailed description of example embodiments of the system introduced in Section A; and
Section G describes example implementations of methods, systems/devices, and computer-readable media in accordance with the present disclosure.
   A. Introduction to Illustrative Embodiments of a System Enabling a Client Device to Request Another Client Device to Initiate Downloading of a File from a Computing System on its Behalf

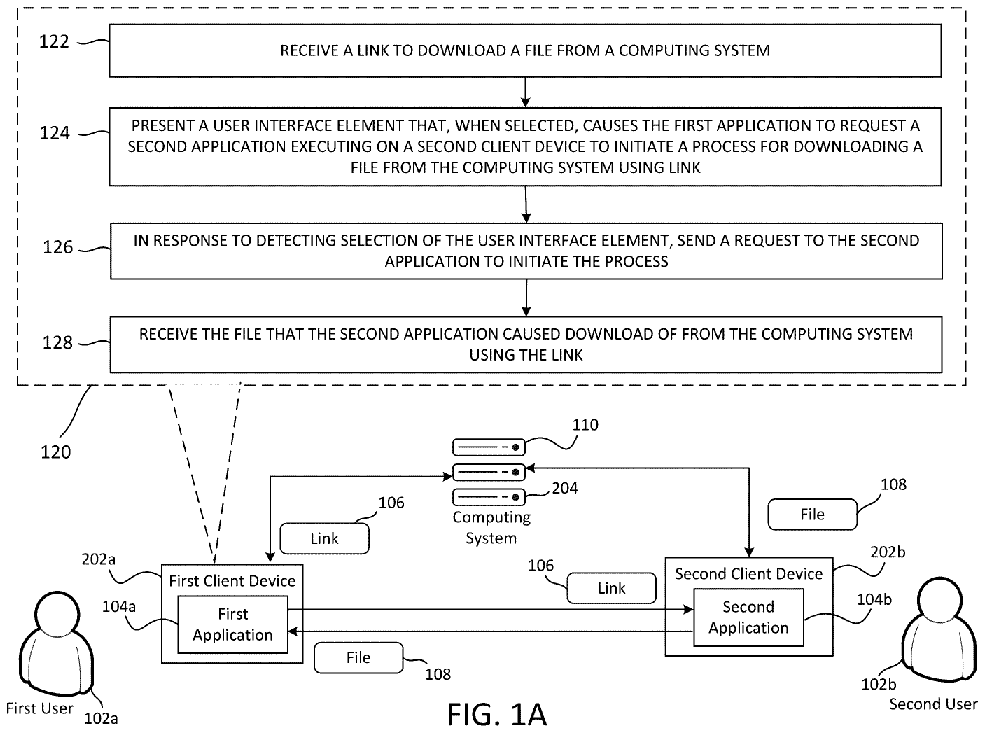

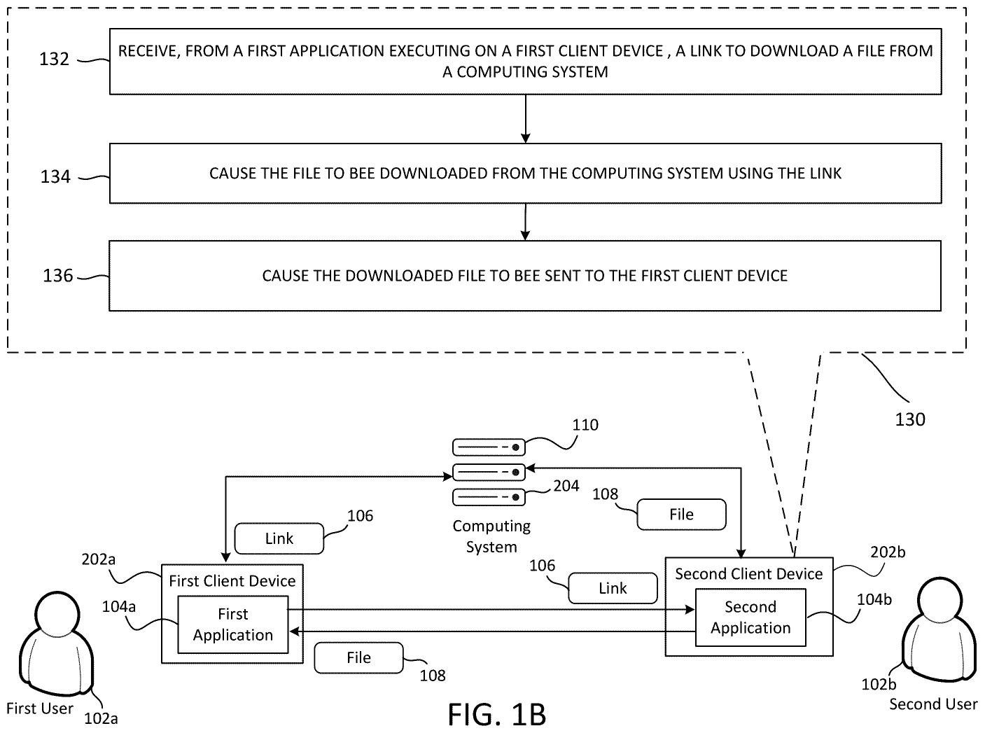

FIGS. 1A and 1B show an example system configuration with which some aspects of the present disclosure may be implemented. As shown, a first client device 202a, operated by a first user 102a, may be in communication with a second client device 202b, operated by a second user 102b. As also shown, the first client device 202a and the second client device 202b may each be in communication with a computing system 110. In some implementations, the first client device 202a may execute a first application 104a and the second client device 202b may execute a second application 104b. In some implementations, one or both of the applications 104a, 104b may be locally installed on the individual client devices 202a, 202b. In other implementations, one or both of the applications 104a, 104b may alternatively be executed via browser(s) that access web-based content from one or more application servers (not illustrated).

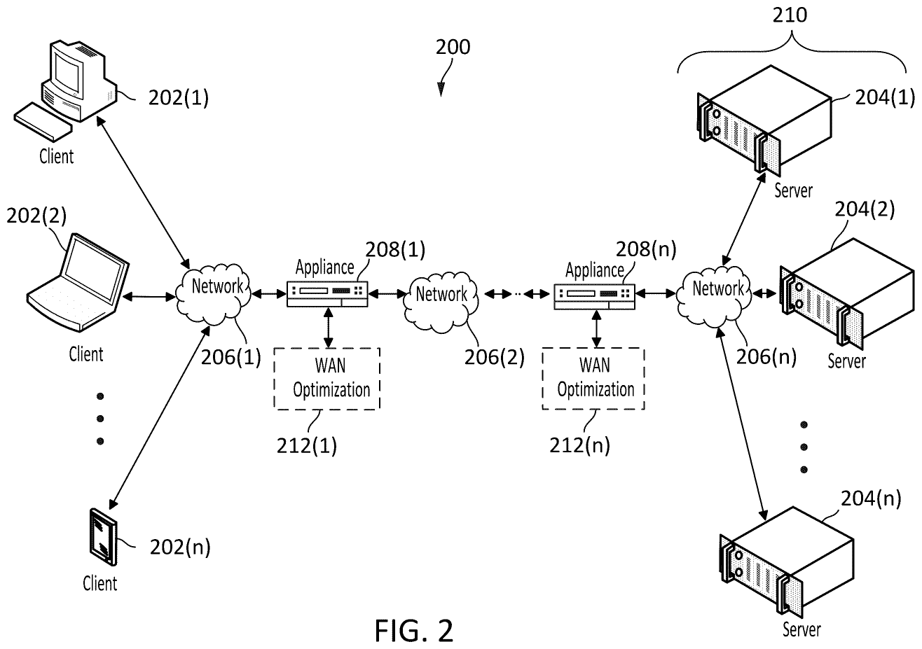

No matter what form they take, the applications 104a, 104b may, in some implementations, be respective modules of a collaboration application 104 (e.g., an internet conferencing application, a messaging application, a communication application, or the like). Examples of the collaboration application 104 include Microsoft Teams, Google Meet, Slack, Amazon Chime, Cisco WebEx Teams, Microsoft Outlook, etc. The collaboration application 104 may be deployed, at least in part, via one or more servers 204. In some implementations, the collaboration application 104 may be provided by a distributed server system, where the servers may be located in different geographic locations, and thus enable individual client devices 202 to connect to a server, which may be referred to as a local server, with the best or highest quality network connection to the client device 202. The computing system 110 may also be implemented by one or more servers 204. Examples of components that may be used to implement the client devices 202a, 202b and the server(s) 204, as well as examples of computing environments in which such components may be deployed, are described below in connection with FIGS. 2-4.

In some implementations, the computing system 110 may be a file sharing system such as the file sharing system 504 described below (in Section E) in connection with FIGS. 5A-C. In other implementations, the computing system 110 may be a private network drive or a private shared drive that may be internal to a group of users, such as an organization, a company, etc. In some implementations, the remote computing system 110 may be deployed at one or more server(s) 204 located in a single geographic location.

FIG. 1A further shows an example routine 120 that may be performed by the first client device 202a to implement some aspects of the present disclosure. In some implementations, the routine 120 may be performed by the first application 104a. A user interface for the first application 104a (e.g., Microsoft Teams) may be open or otherwise active at the first client device 202a.

At a step 122 of the routine 120, the first application 104a (e.g., Microsoft Teams) may receive a link 106 to download a file from the computing system 110. Such a link 106 may be obtained in any of numerous ways. As shown in FIG. 1A, for example, in some implementations, the file link 106 may be received directly from the computing system 110. For instance, where the computing system 110 is a file sharing system (e.g., the file sharing system 504 described in Section E), the first user 102 may operate a file management application 513 (shown in FIG. 5A) to submit a request 514 (see FIG. 5C) to the access management system 506 to obtain a link 522 (corresponding to the link 106) that identifies the file within the storage system 508. Alternatively, the link 106 may have been received from another source, such as from another client device 202 that obtained the link 106 from the access management system 506 and sent the link 106 to the client device 202a via an email or other message. In either case, the first user 102a may, for example, copy and paste the link 106 to an appropriate location within a UI presented by the first application 104a (e.g., Microsoft Teams), thus causing the first application to receive the link 106. Where the computing system 110 is an internal network drive, or the like, the link 106 may instead be a path identifier identifying the location of the drive on an intranet. The first application 104a may likewise receive such a link 106 in response to the user 102a copying and pasting (or simply typing) the link 106 to an appropriate location within a user interface presented by the first application 104a. The link 106 may be configured such that selection of the link 106 initiates a process for the downloading a file 108 from the computing system 110.

At a step 124 of the routine 120, the first application 104 may cause the first client device 202a to present a user interface element that, when selected, causes the first application 104a to request the second application 104b executing on the second client device 202b to initiate a process for downloading the file 108 from the computing system 110 using the link 106. The user interface element may be a button, an icon, or other type of user interface element. In some implementations, the user interface element may be presented (e.g., displayed) while the link 106 is also presented (e.g., displayed) via the user interface of the first application 104a.

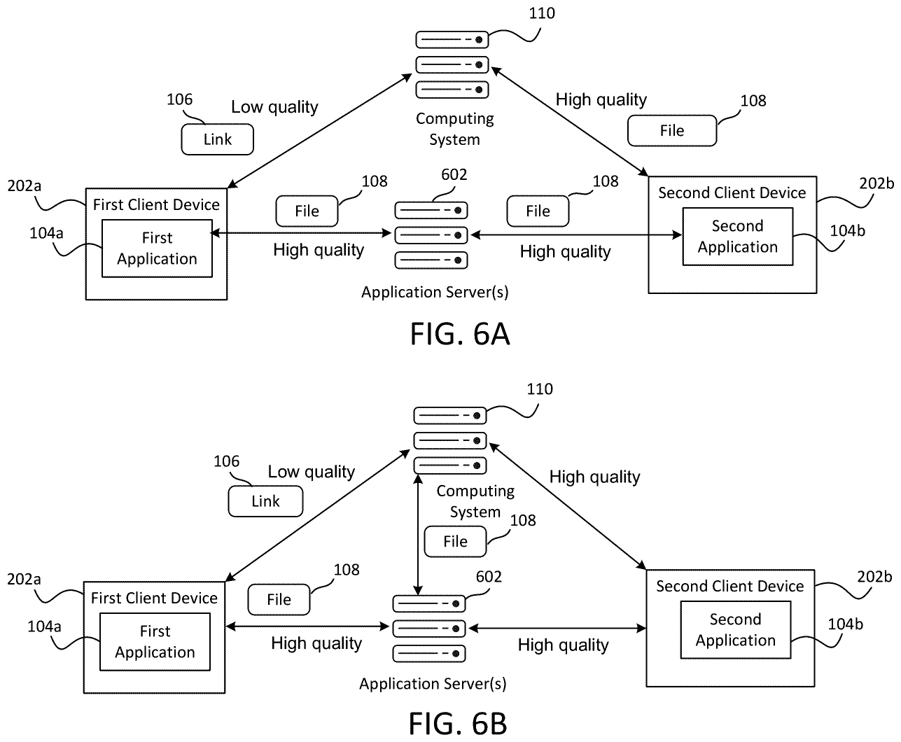

At a step 126 of the routine 120, in response to detecting selection of the user interface element, the first application 104a may cause the client device 202a to send a request to the second application 104b to initiate the process for downloading the file 108. Although not shown in FIG. 1A, such request may be communicated by the first application 104a to the second application 104b via one or more application servers (e.g., application server(s) 602 described below in connection with FIGS. 6A and 6B). The first user 102a may select the user interface element, presented by the first application 104a, which may cause the first application 104a to send the request (including the link 106) to the second application 104b (e.g., via one or more applications servers 602). As described below in connection with FIG. 1B, receipt of the request by the second application 104b may cause the second application 104b to initiate the process of downloading the file 108, using the link 106, from the computing system 110.

At a step 128 of the routine 120, the first client device 202a may receive the file 108 that the second application 104b caused to be downloaded from the computing system 110 using the link 106. Although not illustrated in FIG. 1A, the file 108 may be transferred from the second application 104b to the first application 104a via one or more application servers 602. In this manner, the first client device 202a may receive the file 108 indirectly from the computing system 110 (via the second client device 202b and/or one or more application servers 602), rather than downloading it directly from the computing system 110. In some cases, the network connection between the first client device 202a and the computing system 110 may be slower or of a lower quality than the network connection between the second client device 202b and the computing system 110, such that download of the file 108 from the computing system 110 is more efficient by the second client device 202b than the first client device 202a. Additionally, the network connection between the first client device 202a and the computing system 110 may also be slower or of lower quality than the network connection between the first application 104a and the second application 104b (e.g., via one or more application servers 602). Thus, the system may take advantage of multiple higher quality connections (i.e., between the computing system 110 and the second client device 202b, between the second client device 202b and an application server 602, and between the application server 602 and the first client device 202a) to obtain a faster download/file transfer speed from the computing system 110 to the first client device 202a than could be obtained using the lower quality connection (e.g., a VPN connection) between the first client device 202a and the computing system 110.

FIG. 1B shows an example routine 130 that may be performed by the second client device 202b to implement some aspects of the present disclosure. In some implementations, the routine 130 may be performed by the second application 104b. A user interface for the second application 104b may be open or otherwise active at the second client device 202b.

At a step 132 of the routine 130, the second application 104b may receive, from the first application 104a executing on the first client device 202a, the link 106 to download the file 108 from the computing system 110. In some implementations, the link 106 may be presented (e.g., displayed) via the user interface of the second application 104b. In some implementations, in response to receiving the link 106, the second application 104b may cause the second client device 202b to present one or more user interface elements that can be selected by the second user 102b to either approve or reject downloading of the file 108. In response to the second application 104b detecting selection of an “approve” user interface element, the second application 104b may automatically (A) cause the file 108 to be downloaded from the computing system 110 using the link 106 (per a step 134), and (B) cause the downloaded file 108 to be sent to the first client device 202a (per a step 136).

In some implementations, to cause the file 108 to be downloaded (per the step 134), the second application 104b may send a request (e.g., a hypertext transport protocol (HTTP) request, an application programming interface (API) request, a command, etc.) to the computing system 110 to download the file 108, and the computing system 110 may proceed with the download to the second client device 202b based on information (a download token, a file path, etc.) represented in the link 106. In other implementations, the second application 104b may instead instruct an application server 602 (not shown in FIG. 1B) to use the link 106 to download the file 108 to server-based storage.

In some implementations, to cause the downloaded file 108 to be sent to the first client device 104a, the second application 104b may cause the downloaded file 108 to be temporarily stored on the second client device 202b, and then sent to the first application 104a, e.g., via one or more application servers 602. In other implementations, the second application 104b may instead instruct an application server 602 (not shown in FIG. 1B) to send the file 108 to the first application 104a after the file 108 has been downloaded to server-based storage.

Additional details and example implementations of embodiments of the present disclosure are set forth below in Section F, following a description of example systems and network environments in which such embodiments may be deployed.

### B. Network Environment

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, FL, such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, FL, such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+ an organization.

### C. Computing Environment

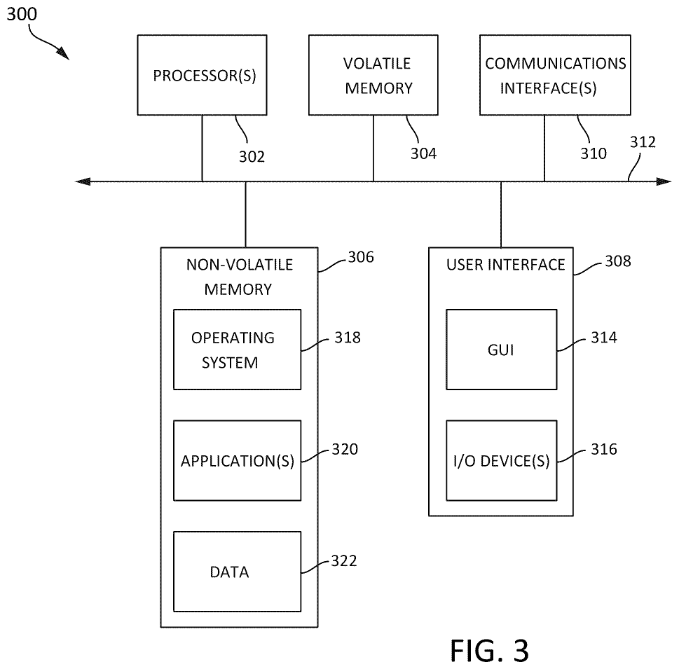

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

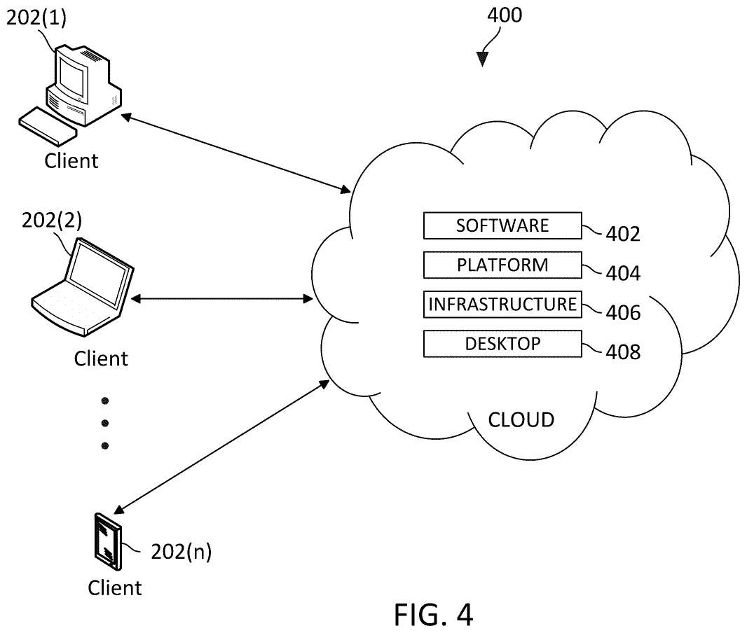

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. Citrix ShareFile from Citrix Systems, DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Washington, or AMAZON WEB SERVICES provided by Amazon.com, Inc., of Seattle, Washington, for example. In the case of Citrix Cloud, Citrix Workspace app may be used as a single-entry point for bringing apps, files and desktops together (whether on-premises or in the cloud) to deliver a unified experience.

### E. Systems and Methods for Providing File Sharing Over Network(s)

FIG. 5A shows an example network environment 500 for allowing an authorized client 202 and/or an unauthorized client 202b to upload a file 502 to a file sharing system 504 or download a file 502 from the file sharing system 504. The authorized client 202 may, for example, be a client 202 operated by a user having an active account with the file sharing system 504, while the unauthorized client 202b may be operated by a user who lacks such an account. As shown, in some embodiments, the authorized client 202 may include a file management application 513 with which a user of the authorized client 202 may access and/or manage the accessibility of one or more files 502 via the file sharing system 504. The file management application 513 may, for example, be a mobile or desktop application installed on the authorized client 202 (or in a computing environment accessible by the authorized client). The ShareFile© mobile app and the ShareFile© desktop app offered by Citrix Systems, Inc., of Fort Lauderdale, FL, are examples of such preinstalled applications. In other embodiments, rather than being installed on the authorized client 202, the file management application 513 may be executed by a web server (included with the file sharing system 504 or elsewhere) and provided to the authorized client 202 via one or more web pages.

As FIG. 5A illustrates, in some embodiments, the file sharing system 504 may include an access management system 506 and a storage system 508. As shown, the access management system 506 may include one or more access management servers 204a and a database 510, and the storage system 508 may include one or more storage control servers 204b and a storage medium(s) 512. In some embodiments, the access management server(s) 204a may, for example, allow a user of the file management application 513 to log in to his or her account, e.g., by entering a user name and password corresponding to account data stored in the database 510. Once the user of the client 202 has logged in, the access management server 204a may enable the user to view (via the authorized client 202) information identifying various folders represented in the storage medium(s) 512, which is managed by the storage control server(s) 204b, as well as any files 502 contained within such folders. File/folder metadata stored in the database 510 may be used to identify the files 502 and folders in the storage medium(s) 512 to which a particular user has been provided access rights.

In some embodiments, the clients 202, 202b may be connected to one or more networks 206a (which may include the Internet), the access management server(s) 204a may include webservers, and an appliance 208a may load balance requests from the authorized client 202 to such webservers. The database 510 associated with the access management server(s) 204a may, for example, include information used to process user requests, such as user account data (e.g., username, password, access rights, security questions and answers, etc.), file and folder metadata (e.g., name, description, storage location, access rights, source IP address, etc.), and logs, among other things. Although the clients 202, 202b are shown is FIG. 5A as stand-alone computers, it should be appreciated that one or both of the clients 202, 202b shown in FIG. 5A may instead represent other types of computing devices or systems that can be operated by users. In some embodiments, for example, one or both of the authorized client 202 and the unauthorized client 202b may be implemented as a server-based virtual computing environment that can be remotely accessed using a separate computing device operated by users, such as described above.

In some embodiments, the access management system 506 may be logically separated from the storage system 508, such that files 502 and other data that are transferred between clients 202 and the storage system 508 do not pass through the access management system 506. Similar to the access management server(s) 204a, one or more appliances 208b may load-balance requests from the clients 202, 202b received from the network(s) 206a (which may include the Internet) to the storage control server(s) 204b. In some embodiments, the storage control server(s) 204b and/or the storage medium(s) 512 may be hosted by a cloud-based service provider (e.g., Amazon Web Services™ or Microsoft Azure™). In other embodiments, the storage control server(s) 204b and/or the storage medium(s) 512 may be located at a data center managed by an enterprise of a client 202, or may be distributed among some combination of a cloud-based system and an enterprise system, or elsewhere.

After a user of the authorized client 202 has properly logged in to an access management server 204a, the server 204a may receive a request from the client 202 for access to one of the files 502 or folders to which the logged in user has access rights. The request may either be for the authorized client 202 to itself to obtain access to a file 502 or folder or to provide such access to the unauthorized client 202b. In some embodiments, in response to receiving an access request from an authorized client 202, the access management server 204a may communicate with the storage control server(s) 204b (e.g., either over the Internet via appliances 208a and 208b or via an appliance 208c positioned between networks 206b and 206c) to obtain a token generated by the storage control server 204b that can subsequently be used to access the identified file 502 or folder.

In some implementations, the generated token may, for example, be sent to the authorized client 202, and the authorized client 202 may then send a request for a file 502, including the token, to the storage control server(s) 204b. In other implementations, the authorized client 202 may send the generated token to the unauthorized client 202b so as to allow the unauthorized client 202b to send a request for the file 502, including the token, to the storage control server(s) 204b. In yet other implementations, an access management server 204a may, at the direction of the authorized client 202, send the generated token directly to the unauthorized client 202b so as to allow the unauthorized client 202b to send a request for the file 502, including the token, to the storage control server(s) 204b. In any of the forgoing scenarios, the request sent to the storage control server(s) 204b may, in some embodiments, include a uniform resource locator (URL) that resolves to an internet protocol (IP) address of the storage control server(s) 204b, and the token may be appended to or otherwise accompany the URL. Accordingly, providing access to one or more clients 202 may be accomplished, for example, by causing the authorized client 202 to send a request to the URL address, or by sending an email, text message or other communication including the token-containing URL to the unauthorized client 202b, either directly from the access management server(s) 204a or indirectly from the access management server(s) 204a to the authorized client 202 and then from the authorized client 202 to the unauthorized client 202b. In some embodiments, selecting the URL or a user interface element corresponding to the URL, may cause a request to be sent to the storage control server(s) 204b that either causes a file 502 to be downloaded immediately to the client that sent the request, or may cause the storage control server 204b to return a webpage to the client that includes a link or other user interface element that can be selected to effect the download.

In some embodiments, a generated token can be used in a similar manner to allow either an authorized client 202 or an unauthorized client 202b to upload a file 502 to a folder corresponding to the token. In some embodiments, for example, an “upload” token can be generated as discussed above when an authorized client 202 is logged in and a designated folder is selected for uploading. Such a selection may, for example, cause a request to be sent to the access management server(s) 204a, and a webpage may be returned, along with the generated token, that permits the user to drag and drop one or more files 502 into a designated region and then select a user interface element to effect the upload. The resulting communication to the storage control server(s) 204b may include both the to-be-uploaded file(s) 502 and the pertinent token. On receipt of the communication, a storage control server 204b may cause the file(s) 502 to be stored in a folder corresponding to the token.

In some embodiments, sending a request including such a token to the storage control server(s) 204b (e.g., by selecting a URL or user-interface element included in an email inviting the user to upload one or more files 502 to the file sharing system 504), a webpage may be returned that permits the user to drag and drop one or more files 502 into a designated region and then select a user interface element to effect the upload. The resulting communication to the storage control server(s) 204b may include both the to-be-uploaded file(s) 502 and the pertinent token. On receipt of the communication, a storage control server 204b may cause the file(s) 502 to be stored in a folder corresponding to the token.

In the described embodiments, the clients 202, servers 204, and appliances 208 and/or 212 (appliances 212 are shown in FIG. 2) may be deployed as and/or executed on any type and form of computing device, such as any desktop computer, laptop computer, rack-mounted computer, or mobile device capable of communication over at least one network and performing the operations described herein. For example, the clients 202, servers 204 and/or appliances 208 and/or 212 may correspond to respective computing systems, groups of computing systems, or networks of distributed computing systems, such as computing system 300 shown in FIG. 3.

As discussed above in connection with FIG. 5A, in some embodiments, a file sharing system may be distributed between two sub-systems, with one subsystem (e.g., the access management system 506) being responsible for controlling access to files 502 stored in the other subsystem (e.g., the storage system 508). FIG. 5B illustrates conceptually how one or more clients 202 may interact with two such subsystems.

As shown in FIG. 5B, an authorized user operating a client 202, which may take on any of numerous forms, may log in to the access management system 506, for example, by entering a valid user name and password. In some embodiments, the access management system 506 may include one or more webservers that respond to requests from the client 202. The access management system 506 may store metadata concerning the identity and arrangements of files 502 (shown in FIG. 5A) stored by the storage system 508, such as folders maintained by the storage system 508 and any files 502 contained within such folders. In some embodiments, the metadata may also include permission metadata identifying the folders and files 502 that respective users are allowed to access. Once logged in, a user may employ a user-interface mechanism of the client 202 to navigate among folders for which the metadata indicates the user has access permission.

In some embodiments, the logged-in user may select a particular file 502 the user wants to access and/or to which the logged-in user wants a different user of a different client 202 to be able to access. Upon receiving such a selection from a client 202, the access management system 506 may take steps to authorize access to the selected file 502 by the logged-in client 202 and/or the different client 202. In some embodiments, for example, the access management system 506 may interact with the storage system 508 to obtain a unique “download” token which may subsequently be used by a client 202 to retrieve the identified file 502 from the storage system 508. The access management system 506 may, for example, send the download token to the logged-in client 202 and/or a client 202 operated by a different user. In some embodiments, the download token may a single-use token that expires after its first use.

In some embodiments, the storage system 508 may also include one or more webservers and may respond to requests from clients 202. In such embodiments, one or more files 502 may be transferred from the storage system 508 to a client 202 in response to a request that includes the download token. In some embodiments, for example, the download token may be appended to a URL that resolves to an IP address of the webserver(s) of the storage system 508. Access to a given file 502 may thus, for example, be enabled by a “download link” that includes the URL/token. Such a download link may, for example, be sent the logged-in client 202 in the form of a “DOWNLOAD” button or other user-interface element the user can select to effect the transfer of the file 502 from the storage system 508 to the client 202. Alternatively, the download link may be sent to a different client 202 operated by an individual with which the logged-in user desires to share the file 502. For example, in some embodiments, the access management system 506 may send an email or other message to the different client 202 that includes the download link in the form of a “DOWNLOAD” button or other user-interface element, or simply with a message indicating “Click Here to Download” or the like. In yet other embodiments, the logged-in client 202 may receive the download link from the access management system 506 and cut-and-paste or otherwise copy the download link into an email or other message the logged in user can then send to the other client 202 to enable the other client 202 to retrieve the file 502 from the storage system 508.

In some embodiments, a logged-in user may select a folder on the file sharing system to which the user wants to transfer one or more files 502 (shown in FIG. 5A) from the logged-in client 202, or to which the logged-in user wants to allow a different user of a different client 202 to transfer one or more files 502. Additionally or alternatively, the logged-in user may identify one or more different users (e.g., by entering their email addresses) the logged-in user wants to be able to access one or more files 502 currently accessible to the logged-in client 202.

Similar to the file downloading process described above, upon receiving such a selection from a client 202, the access management system 506 may take steps to authorize access to the selected folder by the logged-in client 202 and/or the different client 202. In some embodiments, for example, the access management system 506 may interact with the storage system 508 to obtain a unique “upload token” which may subsequently be used by a client 202 to transfer one or more files 502 from the client 202 to the storage system 508. The access management system 506 may, for example, send the upload token to the logged-in client 202 and/or a client 202 operated by a different user.

One or more files 502 may be transferred from a client 202 to the storage system 508 in response to a request that includes the upload token. In some embodiments, for example, the upload token may be appended to a URL that resolves to an IP address of the webserver(s) of the storage system 508. For example, in some embodiments, in response to a logged-in user selecting a folder to which the user desires to transfer one or more files 502 and/or identifying one or more intended recipients of such files 502, the access management system 506 may return a webpage requesting that the user drag-and-drop or otherwise identify the file(s) 502 the user desires to transfer to the selected folder and/or a designated recipient. The returned webpage may also include an “upload link,” e.g., in the form of an “UPLOAD” button or other user-interface element that the user can select to effect the transfer of the file(s) 502 from the client 202 to the storage system 508.

In some embodiments, in response to a logged-in user selecting a folder to which the user wants to enable a different client 202 operated by a different user to transfer one or more files 502, the access management system 506 may generate an upload link that may be sent to the different client 202. For example, in some embodiments, the access management system 506 may send an email or other message to the different client 202 that includes a message indicating that the different user has been authorized to transfer one or more files 502 to the file sharing system, and inviting the user to select the upload link to effect such a transfer. Section of the upload link by the different user may, for example, generate a request to webserver(s) in the storage system and cause a webserver to return a webpage inviting the different user to drag-and-drop or otherwise identify the file(s) 502 the different user wishes to upload to the file sharing system 504. The returned webpage may also include a user-interface element, e.g., in the form of an “UPLOAD” button, that the different user can select to effect the transfer of the file(s) 502 from the client 202 to the storage system 508. In other embodiments, the logged-in user may receive the upload link from the access management system 506 and may cut-and-paste or otherwise copy the upload link into an email or other message the logged-in user can then send to the different client 202 to enable the different client to upload one or more files 502 to the storage system 508.

In some embodiments, in response to one or more files 502 being uploaded to a folder, the storage system 508 may send a message to the access management system 506 indicating that the file(s) 502 have been successfully uploaded, and an access management system 506 may, in turn, send an email or other message to one or more users indicating the same. For user's that have accounts with the file sharing system 504, for example, a message may be sent to the account holder that includes a download link that the account holder can select to effect the transfer of the file 502 from the storage system 508 to the client 202 operated by the account holder. Alternatively, the message to the account holder may include a link to a webpage from the access management system 506 inviting the account holder to log in to retrieve the transferred files 502. Likewise, in circumstances in which a logged-in user identifies one or more intended recipients for one or more to-be-uploaded files 502 (e.g., by entering their email addresses), the access management system 506 may send a message including a download link to the designated recipients (e.g., in the manner described above), which such designated recipients can then use to effect the transfer of the file(s) 502 from the storage system 508 to the client(s) 202 operated by those designated recipients.

FIG. 5C is a block diagram showing an example of a process for generating access tokens (e.g., the upload tokens and download tokens discussed above) within the file sharing system 504 described in connection with FIGS. 5A and 5B.

As shown, in some embodiments, a logged-in client 202 may initiate the access token generation process by sending an access request 514 to the access management server(s) 204b. As noted above, the access request 514 may, for example, correspond to one or more of (A) a request to enable the downloading of one or more files 502 (shown in FIG. 5A) from the storage system 508 to the logged-in client 202, (B) a request to enable the downloading of one or more files 502 from the storage system 508 to a different client 202 operated by a different user, (C) a request to enable the uploading of one or more files 502 from a logged-in client 202 to a folder on the storage system 508, (D) a request to enable the uploading of one or more files 502 from a different client 202 operated by a different user to a folder of the storage system 508, (E) a request to enable the transfer of one or more files 502, via the storage system 508, from a logged-in client 202 to a different client 202 operated by a different user, or (F) a request to enable the transfer of one or more files 502, via the storage system 508, from a different client 202 operated by a different user to a logged-in client 202.

In response to receiving the access request 514, an access management server 204a may send a “prepare” message 516 to the storage control server(s) 204b of the storage system 508, identifying the type of action indicated in the request, as well as the identity and/or location within the storage medium(s) 512 of any applicable folders and/or files 502. As shown, in some embodiments, a trust relationship may be established (step 518) between the storage control server(s) 204b and the access management server(s) 204a. In some embodiments, for example, the storage control server(s) 204b may establish the trust relationship by validating a hash-based message authentication code (HMAC) based on shared secret or key 530).

After the trust relationship has been established, the storage control server(s) 204b may generate and send (step 520) to the access management server(s) 204a a unique upload token and/or a unique download token, such as those as discussed above.

After the access management server(s) 204a receive a token from the storage control server(s) 204b, the access management server(s) 204a may prepare and send a link 522 including the token to one or more client(s) 202. In some embodiments, for example, the link may contain a fully qualified domain name (FQDN) of the storage control server(s) 204b, together with the token. As discussed above, the link 522 may be sent to the logged-in client 202 and/or to a different client 202 operated by a different user, depending on the operation that was indicated by the request.

The client(s) 202 that receive the token may thereafter send a request 524 (which includes the token) to the storage control server(s) 204b. In response to receiving the request, the storage control server(s) 204b may validate (step 526) the token and, if the validation is successful, the storage control server(s) 204b may interact with the client(s) 202 to effect the transfer (step 528) of the pertinent file(s) 502, as discussed above.

### F. Detailed Description of Example Embodiments of the System Introduced in Section A

As described above in Section A, the present disclosure relates to a system in which a first client device 202a may request a second client device 202b to cause a file 108 to be downloaded from a computing system 110 and sent to the first client device 202a. FIGS. 6A and 6B are diagrams illustrating example configurations of a system that may be used to implement certain of the functionalities described herein. As shown in FIGS. 6A and 6B, the first client device 202a may be in communication with the computing system 110 using a relatively low quality network connection (e.g., a VPN connection), and the second client device 202b may be in communication with the computing system 110 using a higher quality network connection. The first client device 202a and the second client device 202b may be in communication with each other via the first application 104a and the second application 104b. As shown, communications between the first application 104a and the second application 104b may take place through one or more application server(s) 602. In some embodiments, for example, the applications server(s) 602 may implement a server-based collaboration application 104 (e.g., Microsoft Teams), and the first application 104b and the second application 104b may be local or browser-based modules of that collaboration application 104.

In some implementations, the computing system 110 may be deployed within an intranet or other private network to which access is controlled with respect to a group of users (e.g., an organization, a company, etc.). In some implementations, the first client device 202a may be remotely connected to the private network in which the computing system 110 is deployed, using a VPN connection, a gateway, or another remote connection type. For example, the first user 102a (shown in FIGS. 1A and 1B) may be working from home or another location outside of the private network. As such, the computing system 110 may be remotely located from the first client device 202a. The remote connection between the first client device 202a and the computing system 110 may be of a relatively low quality, such that the bandwidth and/or other performance metrics related to the network connection affect the first client device's efficiency or ability in downloading a file 108 from the computing system 110.

In some implementations, the first client device 202a may be in a different geographic location than the computing system 110. In such implementations, the distance between the first client device 202a and the computing system 110 may affect the network quality, bandwidth, and/or other performance metrics of the network connection, which may in turn affect the first client device's efficiency or ability in downloading a file from the computing system 110.

In some implementations, the second client device 202b may be connected to the computing system 110 via the private network in which the computing system 110 is deployed. For example, the second user 102b (shown in FIGS. 1A and 1B) may be working from the office, and the second client device 202b may be directly connected to the same network as the computing system 110. As such, the computing system 110 may be local to the second client device 202a. The network connection between the second client device 202b and the computing system 110 may be of higher quality than the network connection between the first client device 202a and the computing system 110, thus enabling the second client device 202b to download a file from the computing system 110 more efficiently than the first client device 202a.

As shown in FIGS. 6A and 6B, the first client device 202a may execute the first application 104a, and the second client device 202b may execute the second application 104b. As noted previously, in some implementations, the application 104 may be a collaboration application, such as an internet conferencing application, a messaging application, a communication application, or the like. Examples of the application 104 include Microsoft Teams, Google Meet, Slack, Amazon Chime, Cisco Webex Teams, etc.

When the first client device 202a and the second client device 202b communicate with each other via the application 104 (e.g., to request download of a file and to send the downloaded file, as described herein), such communications may occur via the application server(s) 602. In some implementations, the network connection between the application server(s) 602 and the client devices 202 may be better or of a higher quality than the connection between the first client device 202a and the computing system 110.

Given the network configurations of the system illustrated in FIGS. 6A and 6B, it may be more efficient to download a file 108 from the computing system 110 to the first client device 202a indirectly, e.g., via the application server(s) 602, than for the first client device 202a to download the file 108 directly from the computing system 110. In other words, a slower, direct download path (from the computing system 110 to the first client device 202a) may be replaced with two or more faster, indirect download paths to improve the speed at which the file 108 can be transferred from the computing system 110 to the first client device 202a.

Referring to FIG. 6A, in some implementations, the second application 104b may cause the file 108 to be downloaded to the second client device 202b, and the file 108 may be temporarily stored in a memory (e.g., cache) of the second client device 202b. In such implementations, the second application 104b/the second client device 202b may provide the file 108 to the first application 104a/the first client device 202a via the application server(s) 602 using the higher quality connections between the client devices 202a, 202b and the application server(s) 602.

Referring to FIG. 6B, in some implementations, the second application 104b may instead cause the file 108 to be downloaded to the application server(s) 602. For example, in such implementations, the second application 104b may instruct the application server(s) 602 to use the link 106 to retrieve the file 108 from computing system 110, and send the file 108 to the first client device 202a/first application 104a after it has been downloaded. The application server(s) 602 may be in communication with the computing system 110, e.g., via one or more networks, for this purpose. In some implementations, a locally available application server 602 may be in communication with the computing system 110. The file 108 may be temporarily stored (e.g., in cache) at the application server(s) 602 and provided to the first application 104a/the first client device 202a by the applications server(s) 602 via the higher quality connection between the application server(s) 602 and the first client device 202a.

In some implementations, the respective client devices 202 may include one or more processors as well as one or more computer-readable mediums that are encoded with instructions to be executed by the processor(s). In some implementations, such instructions may cause the processor(s) to implement one or more, or possibly all, of the operations described herein.

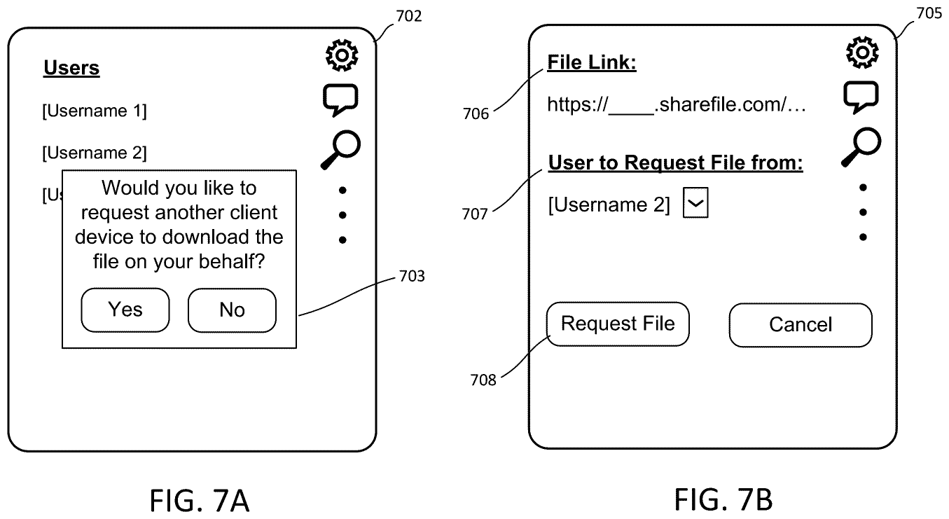

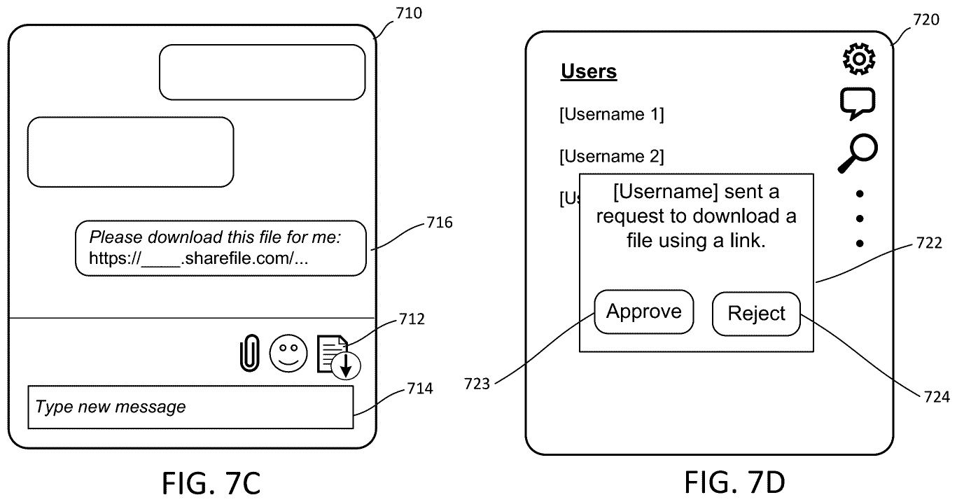

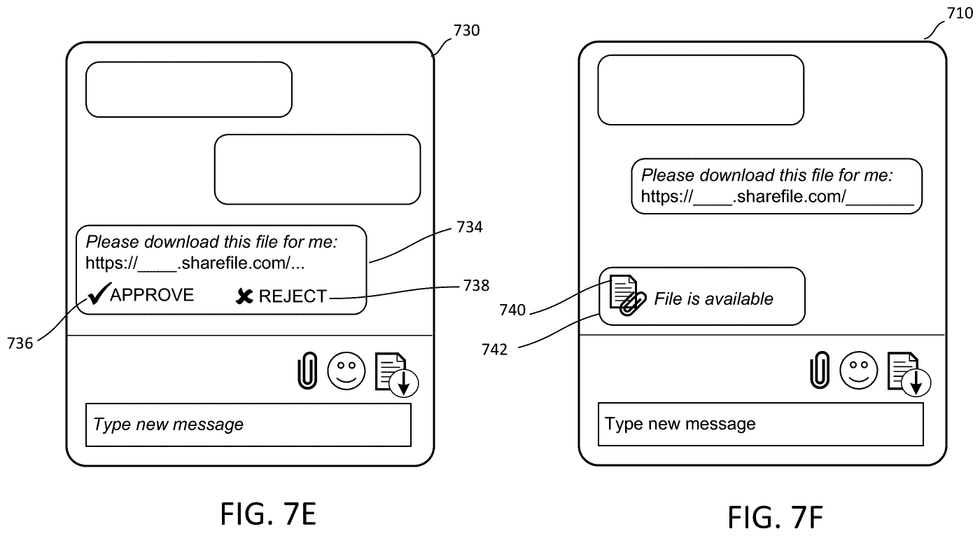

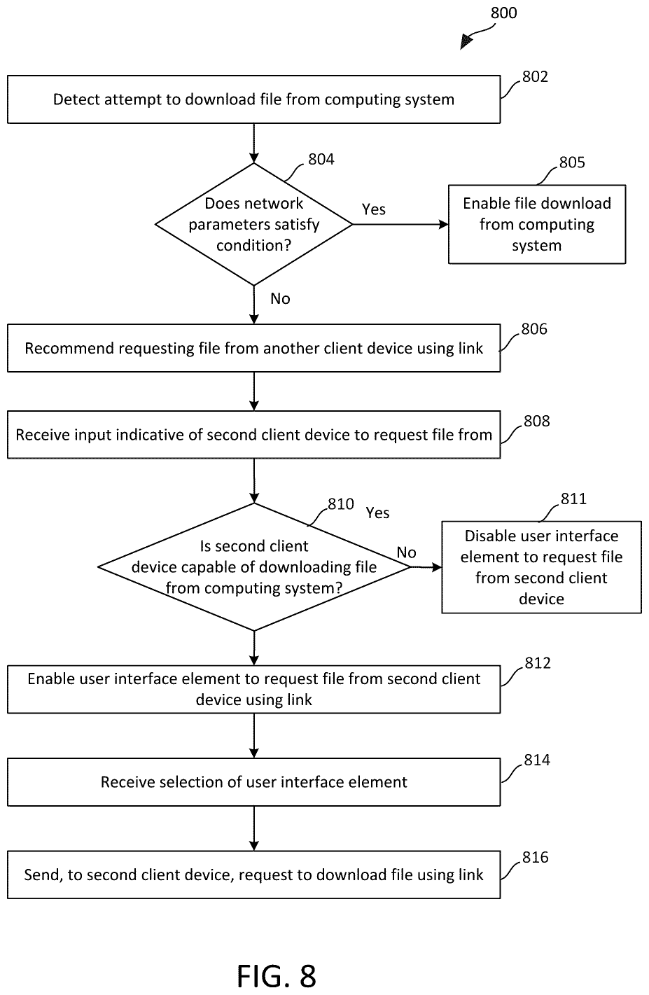

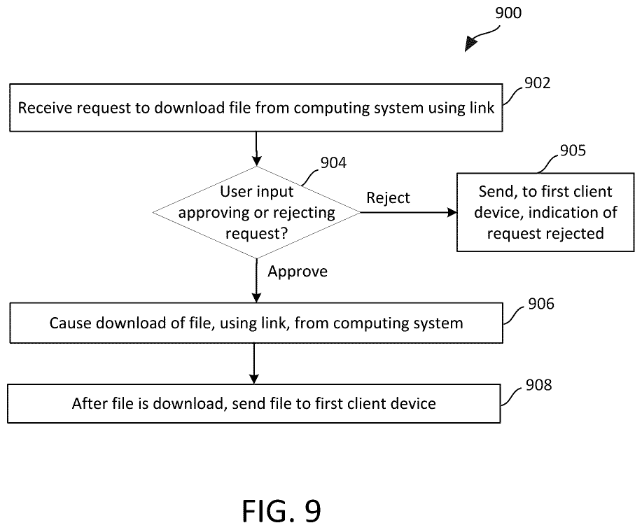

FIGS. 7A-7C illustrate example user interface screens of the application 104, which may be presented via the client devices 202. Those user interface screens are described below in conjunction with the description of FIGS. 8 and 9.

FIG. 8 is a flowchart illustrating an example routine 800 that may be performed at the first client device 202a. One or more steps of the routine 800 may be performed via the first application 104a. At a step 802 of the routine 800, the first client device 202a may detect an attempt to download a file 108 from the computing system 110. The first client device 202a may detect such an attempt, for example, by determining that a user has selected a link 106 (e.g., a URL, file path, etc.) corresponding to the computing system 110.

At a decision step 804 of the routine 800, the first client device 202a may determine whether one or more parameters of the network connection between the first client device 202a and the computing system 110 satisfy a condition. The parameters of the network connection may include, for example, a strength of the network connection (e.g., high, medium, low), the bandwidth available for download, and/or other performance metrics. In some implementations, in determining whether the condition is satisfied, the first client device 202a may determine whether the network strength and/or bandwidth is sufficient to download the requested file within a particular time period, where such determination may depend on the size of the file 108. For example, the first client device 202a may determine whether the file 108 can be downloaded in less than one minute given the download bandwidth of the network. As another example, the first client device 202a may determine whether the network strength is high enough to download the file 108 in less than two minutes. Another parameter of the network connection may be whether the connection between the first client device 202a and the computing system 110 is a direct connection or a remote connection (e.g., via a gateway/VPN). One condition to satisfy may be that the network connection is a direct connection.

If, at the decision step 804, the first client device 202a determines that the network connection parameter(s) satisfies the condition, the routine 800 may proceed to a step 805, at which the first client device 202a may enable the file download from the computing system 110 to proceed without interruption. If, on the other hand, the first client device 202a determines (at the decision step 804) that the network connection parameter(s) does not satisfy the condition, then the routine 800 may instead proceed to a step 806, at which the first client device 202a may present (via the first application 104a) a recommendation to request another client device to download the file 108, using a link (e.g., the link 106 described above in Section A), on behalf of the first client device 202a. In some implementations, for example, the first application 104a may cause the first client device 202a to present a popup window requesting the first user 102a to indicate whether the first user 102a wishes to make such a request. An example of such a popup window 703 is shown in FIG. 7A, which may be presented by the first application 104a via a UI screen 702 shown in FIG. 7A.

If the first user 102a indicates that such a request is to be made (e.g., by clicking a “Yes” UI element within a popup window), the first application 104a may cause the first client device 202a to present a UI screen that allows the user to identify another user and/or client device to which such a request is to be sent. An example of such a UI screen 705 is shown in FIG. 7B. As shown in FIG. 7B, in some implementations, the first application 104a may automatically populate a first field 706 in the UI screen 705 with the link 106 that the first user 102a previously selected (or received from the computing system 110 as described above in Section A). As also shown, the first application 104a may additionally provide a second field 707 in which another user (e.g. the second user 102b) operating another client device (e.g., the second client device 202b) may be identified. In some implementations, the first application 104a may further provide one or more tools, e.g., drop down menus, address books, etc., to assist the first user 102a in identifying another user and/or client device that is available to assist with the downloading of the file 108.

In other implementations, the UI screen 705 may additionally or alternatively be accessed via another user interface screen of the application 104. For example, as shown in FIG. 7C, the first application 104a may cause the first client device 202a to present a chat window 710 representing an ongoing conversation/chat between the first user 102a and the second user 102b, and may cause a UI element (e.g., UI element 712) to be presented/enabled within the window 710 that can be selected by the first user 102a to trigger presentation of the UI screen 705. In some implementations, the first user 102a may enter the link 106 into a field 714 shown in FIG. 7C (e.g., by copying and pasting the link 106 from another source, or simply typing text representing the link 106 into the field 714). In some implementations, upon selection of the UI element 712 and with the link 106 entered in the field 714, the first application 104a may populate the first field 706, of the UI screen 705, with the link 106.

At a step 808 of the routine 800, the first application 104a may receive an input indicative of the second client device 202b to request the file 108 from. As described above in relation to FIGS. 7B and 7C, the first user 102a may indicate the second user 102b, operating the second client device 202b, as the user from whom to request download of the file 108.

In response to receiving the input (at the step 808), the first application 104a may determine, at a decision step 810 of the routine 800, whether the second client device 202a is capable of downloading the file 108 from the computing system 110. In some implementations, this determination may be based on whether the second client device 202b is in direct communication with the computing system 110, whether the second client device 202b has a higher quality network connection with the computing system 110 than the first client device 202a, whether the second user 102b is available (e.g., is logged on, has an “available” status, does not have “do not disturb” on, is not signed out, etc.) via the second application 104b executing at the second client device 202b. In some implementations, such determination, by the first application 104a, may be based on receiving data from the second client device 202b or the second application 104b. For example, certain applications may provide an indication on whether a user is working from home (or a non-office location) or is working from an office location. In some implementations, the first application 104a may determine whether the computing system 110 is locally located to the second client device 202b.

If the second client device 202b is not capable of downloading the file 108 (as determined at the decision step 810), then at a step 811 of the routine 800, the first application 104a may disable a UI element (e.g., a UI element 708 shown in FIG. 7B or the UI element 712 shown in FIG. 7C) to request the second client device 202b to download the file 108. If the second client device 202b is capable of downloading the file 108 (as determined at the decision step 810), then at a step 812, the first application 104a may enable the UI element to request the file 108 from the second client device 202b using the link 106.

At a step 814 of the routine 800, the first application 104a may receive selection of the UI interface element 708 shown in FIG. 7B. In response to receiving selection of the UI element 708, at a step 816, the first application 104a may send, to the second application 104b, a request to download the file 108 using the link 106. In some implementations, the first application 104a may send a message 716 as shown in FIG. 7C in response to the UI element 708 being selected, where the message 716 may be sent via the on-going conversation window 710 between the first user 102a and the second user 102b.

FIG. 9 shows an example routine 900 that may be performed by the second application 104b at the second client device 202b. At a step 902 of the routine 900, the second application 104b may receive a request to download the file 108 from the computing system 110 using the link 106. In some implementations, the second application 104b may present the request via a UI screen of the second application 104b. FIG. 7D shows an example of such a UI screen 720. As shown, the UI screen 720 may include a pop-up window 722 informing the second user 102b that the first user 102a (identified by [username]) has sent a request to download a file using a link. In some implementations, the second application 104b may additionally or alternatively present the request to download the file 108 as a message within a chat window of an on-going conversation between the second user 102b and the first user 102a. FIG. 7E shows an example of such a chat window 730 and a message 734.

The second application 104b may present the request along with UI elements that enable the second user 102b to approve or reject the request. For example, as shown in FIG. 7D, the pop-up window 722 may also present an “approve” UI element 723 and a “reject” UI element 724, along with the request. As another example, as shown in FIG. 7E, the message 734 may include an “approve” UI element 736 and a “reject” UI element 738. At a decision step 904 of the routine 900, the second application 104b may determine whether a user input approving or rejecting the request has been received. The second user 102a may select (e.g., using a mouse click, a touchscreen input, a keyboard input, etc.) a UI element (e.g., UI elements 723, 724, 736 or 738) to approve or reject the request.

If a user input rejecting the request is received (as determined at the decision step 904), then at a step 905 of the routine 900, the second application 104b may send, to the first application 104a, an indication of the request being rejected. Such indication may be presented via the UI screen of the first application 104a.

If a user input approving the request is received (as determined at the decision step 904), then at a step 906 of the routine 900, the second application 104b may cause download of the file 108, using the link 106, from the computing system 110. In some implementations, the second application 104b may send a request, e.g., an HTTP request, an API call, or the like to the computing system 110, where such request may include the link 106. In other implementations, the second application 104b may instruct the application server(s) 602 to send such a request (including the link 106) to the computing system 110. The computing system 110, upon receiving the request (including the link 106) may send the file to the second client device 202b or the application server(s) 602 that sent it the request. In some implementations, the file 108 may be stored in a memory (e.g., cache) of the second client device 202b. In other implementations, the file 108 may be stored in a memory of the application server(s) 602.

At a step 908 of the routine 900, after the file 108 has been downloaded, the second application 104b (or the application server(s) 602) may send the file 108 to the first client device 202a. In some implementations in which the file 108 is downloaded to the second client device 202b, the second application 104b may send the file 108 to the first client device 202a via the application server(s) 602. The file 108 may be sent by the second application 104b (or the application server(s) 602) to the first application 104a without further input from the second user 102b. Thus, the second user 102b need not check on the download progress or progress of fulfilling the request.

In some implementations, access to the file 108 may be enabled via a UI screen of the first application 104a. For example, in some implementations, access to the file 108 may be provided via a message in the chat window 710 of an on-going conversation between the first user 102a and the second user 102b. FIG. 7F shows an example of the chat window 710 where a user interface element 740 enabling access to the file 108 is provided in a message 742. The first user 102a may select (e.g., using a mouse click, touchscreen input, keyboard input, etc.) the UI element 740 to download (or otherwise access) the file 108 to a memory of the first client device 202a.

In some implementations, the application 104 may be configured to perform some of the functionalities described herein. Such functionalities may be enabled as a plug-in, an add-in or an extension to the application's 104 existing functionalities.

In some implementations, the request, from the first client device 202a to the second client device 202b, to download the file 108 using the link 106 may be presented as a notification (e.g., an application notification or a push notification) at the second client device 202b. The notification may be provided by the application 104.

In some implementations, the request to download the file 108 may be sent to the second client device 202b regardless of whether the second client device 202b is capable of downloading the file 108. In such cases, the second user 102b may fulfill the request (e.g., approve the request) at a later time when the second client device 202b is available to download the file 108 (e.g., when the second client device 202b is in communication with the computing system 110 with a higher quality connection). For example, the second client device 202b may receive the request to download the file 108 while the second user 102b is working from home, and the second user 102b may approve the request when the second user 102b returns to the office.

In some implementations, the first client device 202a may be referred to as a requesting client device 202a, and the second client device 202b may be referred to as a sending client device 202b.

Although some of the UI screens illustrated in FIGS. 7A-7F illustrate screens of a messaging/communication application, the techniques describe herein may be implemented using other types of applications. For example, the application 104 may be an email application, where the first client device 202a may send an email, via the first application 104a, to the second client device 202b, where the email includes the link 106. The second user 102b may access the email via the second application 104b, where the email may include user interface elements (like the user interface elements 736, 738 shown in FIG. 7B) to enable the second user 102b to approve or reject the request to download the file 108 using the link 106. If the second user 102b approves the request, the second application 104b may cause download of the file 108 from the computing system 110. Once the file 108 has been downloaded, the second application 104b may send (without further input from the second user 102b in some implementations) an email, with the file 108 attached, to the first client device 202a. The first user 102a may download the attached file 108 via the first application 104a.

G. Example Implementations of Methods, Systems, and Computer-Readable Media in Accordance with the Present Disclosure

The following paragraphs (M1) through (M14) describe examples of methods that may be implemented in accordance with the present disclosure.

(M1) A method may be performed that involves receiving, by a first application executing on a first client device, a link to download a file from a computing system, presenting, by the first application and via the first client device, a user interface element that, when selected, causes the first application to request a second application executing on a second client device to initiate a process for downloading the file from the computing system using the link, in response to detecting selection of the user interface element, sending, by the first application, a request to the second application to initiate the process, and receiving, by the first client device, the file that the second application caused download of from the computing system using the link.

(M2) A method may be performed as described in paragraph (M1), wherein the first application and the second application are instances of a collaboration application that enables communication between a first user of the first client device and a second user of the second client device.

(M3) A method may be performed as described in paragraph (M1) or paragraph (M2), wherein a first network connection between the first client device and the second client device is of higher quality than a second network connection between the first client device and the computing system, and wherein the first network connection is established using one or more application servers hosting the first and second applications.

(M4) A method may be performed as described in any of paragraphs (M1) through (M3), wherein the first client device is in communication with the computing system using a virtual private network (VPN) connection, and wherein the second client device is in direct communication with the computing system.

(M5) A method may be performed as described in any of paragraphs (M1) through (M4), and may further involve receiving, by the first client device, a user input to download the file from the computing system, and receiving, by the first client device and from the computing system, the link to download the file.

(M6) A method may be performed as described in any of paragraphs (M1) through (M5), and may further involve receiving, by the first application, an indication that the second client device is in direct communication with the computing system, wherein the user interface element is presented by the first application in response to receiving the indication.

(M7) A method may be performed as described in any of paragraphs (M1) through (M6), and may further involve determining, by the first client device, a network connection quality for a connection between the first client device and the computing system, wherein the first application presents the user interface element based at least in part on the network connection quality.

(M8) A method may be performed that involves receiving, from a first application executing on a first client device and by a second application executing on a second client device, a link to download a file from a computing system, causing, by the second application, the file to be downloaded from the computing system, and causing, by the second application, the downloaded file to be sent to the first client device.

(M9) A method may be performed as described in paragraph (M8), and may further involve receiving, by the second client device and from the first client device, a request to download the file from the computing system, and in response to receiving the request, presenting, by the second application, a user interface element that can be selected to confirm the second client device is to be used to download the file from the computing system, wherein the second application is caused to use the link to download the file from the computing system in response to detecting, by the second application, selection of the user interface element.

(M10) A method may be performed as described in paragraph (M8) or paragraph (M9), wherein the first application and the second application are instances of a collaboration application that enables communication between a first user of the first client device and a second user of the second client device.

(M11) A method may be performed as described in any of paragraphs (M8) through (M10), wherein a first network connection between the first client device and the second client device is of higher quality than a second network connection between the first client device and the computing system, and wherein the first network connection is established using one or more application servers hosting the first and second applications.

(M12) A method may be performed as described in any of paragraphs (M8) through (M11), wherein the downloaded file is stored in a memory of the second client device.

(M13) A method may be performed as described in any of paragraphs (M8) through (M12), wherein the downloaded file is stored at an application server providing the second application to the second client device.

(M14) A method may be performed as described in any of paragraphs (M8) through (M13), wherein the first client device is in communication with the computing system using a virtual private network (VPN) connection, and wherein the second client device is in direct communication with the computing system.

The following paragraphs (S1) through (S14) describe examples of systems and devices that may be implemented in accordance with the present disclosure.

(S1) A first client device may comprise at least one processor and at least one computer-readable medium encoded with instructions which, when executed by the at least one processor, cause the first client device to receive, by a first application executing on the first client device, a link to download a file from a computing system, present, by the first application, a user interface element that, when selected, causes the first application to request a second application executing on a second client device to initiate a process for downloading the file from the computing system using the link, in response to detecting selection of the user interface element, send, by the first application, a request to the second application to initiate the process; and receive the file that the second application caused download of from the computing system using the link.

(S2) A first client device may be configured as described in paragraph (S1), wherein the first application and the second application are instances of a collaboration application that enables communication between a first user of the first client device and a second user of the second client device.

(S3) A first client device may be configured as described in paragraph (S1) or paragraph (S2), wherein a first network connection between the first client device and the second client device is of higher quality than a second network connection between the first client device and the computing system, and wherein the first network connection is established using one or more application servers hosting the first and second applications.

(S4) A first client device may be configured as described in any of paragraphs (S1) through (S3), wherein the first client device is in communication with the computing system using a virtual private network (VPN) connection, and wherein the second client device is in direct communication with the computing system.

(S5) A first client device may be configured as described in any of paragraphs (S1) through (S4), wherein the at least one computer-readable medium may be further encoded with additional instructions which, when executed by the at least one processor, further cause the first client device to receive a user input to download the file from the computing system; and receive, from the computing system, the link to download the file.

(S6) A first client device may be configured as described in any of paragraphs (S1) through (S5), wherein the at least one computer-readable medium may be further encoded with additional instructions which, when executed by the at least one processor, further cause the first client device to receive, by the first application, an indication that the second client device is in direct communication with the computing system, wherein the user interface element is presented by the first application in response to receiving the indication.

(S7) A first client device may be configured as described in any of paragraphs (S1) through (S6), wherein the at least one computer-readable medium may be further encoded with additional instructions which, when executed by the at least one processor, further cause the first client device to determine a network connection quality for a connection between the first client device and the computing system, wherein the first application presents the user interface element based at least in part on the network connection quality.

(S8) A second client device may comprise at least one processor and at least one computer-readable medium encoded with instructions which, when executed by the at least one processor, cause the second client device to receive, from a first application executing on a first client device and by a second application executing on a second client device, a link to download a file from a computing system, cause, by the second application, the file to be downloaded from the computing system, and cause, by the second application, the downloaded file to be sent to the first client device.

(S9) A second client device may be configured as described in paragraph (S8), wherein the at least one computer-readable medium may be further encoded with additional instructions which, when executed by the at least one processor, further cause the second client device to receive, from the first client device, a request to download the file from the computing system, and in response to receiving the request, present, by the second application, a user interface element that can be selected to confirm the second client device is to be used to download the file from the computing system, wherein the second application is caused to use the link to download the file from the computing system in response to detecting, by the second application, selection of the user interface element.

(S10) A second client device may be configured as described in paragraph (S8) or paragraph (S9), wherein the first application and the second application are instances of a collaboration application that enables communication between a first user of the first client device and a second user of the second client device.

(S11) A second client device may be configured as described in any of paragraphs (S8) through (S10), wherein a first network connection between the first client device and the second client device is of higher quality than a second network connection between the first client device and the computing system, and wherein the first network connection is established using one or more application servers hosting the first and second applications.

(S12) A second client device may be configured as described in any of paragraphs (S8) through (S 11), wherein the downloaded file is stored in a memory of the second client device.

(S13) A second client device may be configured as described in any of paragraphs (S8) through (S12), wherein the downloaded file is stored at an application server providing the second application to the second client device.

(S14) A second client device may be configured as described in any of paragraphs (S8) through (S13), wherein the first client device is in communication with the computing system using a virtual private network (VPN) connection, and wherein the second client device is in direct communication with the computing system.

The following paragraphs (CRM1) through (CRM14) describe examples of computer-readable media that may be implemented in accordance with the present disclosure.

(CRM1) At least one non-transitory computer-readable medium may be encoded with instructions which, when executed by at least one processor of a first client device, may cause the first client device to receive, by a first application executing on the first client device, a link to download a file from a computing system, present, by the first application, a user interface element that, when selected, causes the first application to request a second application executing on a second client device to initiate a process for downloading the file from the computing system using the link, in response to detecting selection of the user interface element, send, by the first application, a request to the second application to initiate the process; and receive the file that the second application caused download of from the computing system using the link.

(CRM2) At least one non-transitory computer-readable medium may be configured as described in paragraph (CRM1), wherein the first application and the second application are instances of a collaboration application that enables communication between a first user of the first client device and a second user of the second client device.

(CRM3) At least one non-transitory computer-readable medium may be configured as described in paragraph (CRM1) or paragraph (CRM2), wherein a first network connection between the first client device and the second client device is of higher quality than a second network connection between the first client device and the computing system, and wherein the first network connection is established using one or more application servers hosting the first and second applications.

(CRM4) At least one non-transitory computer-readable medium may be configured as described in any of paragraphs (CRM1) through (CRM3), wherein the first client device is in communication with the computing system using a virtual private network (VPN) connection, and wherein the second client device is in direct communication with the computing system.

(CRM5) At least one non-transitory computer-readable medium may be configured as described in any of paragraphs (CRM1) through (CRM4), and may be further encoded with additional instructions which, when executed by the at least one processor, further cause the first client device to receive a user input to download the file from the computing system; and receive, from the computing system, the link to download the file.

(CRM6) At least one non-transitory computer-readable medium may be configured as described in any of paragraphs (CRM1) through (CRM5), and may be further encoded with additional instructions which, when executed by the at least one processor, further cause the first client device to receive, by the first application, an indication that the second client device is in direct communication with the computing system, wherein the user interface element is presented by the first application in response to receiving the indication.

(CRM7) At least one non-transitory computer-readable medium may be configured as described in any of paragraphs (CRM1) through (CRM6), and may be further encoded with additional instructions which, when executed by the at least one processor, further cause the first client device to determine a network connection quality for a connection between the first client device and the computing system, wherein the first application presents the user interface element based at least in part on the network connection quality.

(CRM8) At least one non-transitory computer-readable medium may be encoded with instructions which, when executed by at least one processor of a second client device, may cause the second client device to receive, from a first application executing on a first client device and by a second application executing on a second client device, a link to download a file from a computing system, cause, by the second application, the file to be downloaded from the computing system, and cause, by the second application, the downloaded file to be sent to the first client device.

(CRM9) At least one non-transitory computer-readable medium may be configured as described in paragraph (CRM8), and may be further encoded with additional instructions which, when executed by the at least one processor, further cause the second client device to receive, from the first client device, a request to download the file from the computing system, and in response to receiving the request, present, by the second application, a user interface element that can be selected to confirm the second client device is to be used to download the file from the computing system, wherein the second application is caused to use the link to download the file from the computing system in response to detecting, by the second application, selection of the user interface element.

(CRM10) At least one non-transitory computer-readable medium may be configured as described in paragraph (CRM8) or paragraph (CRM9), wherein the first application and the second application are instances of a collaboration application that enables communication between a first user of the first client device and a second user of the second client device.

(CRM11) At least one non-transitory computer-readable medium may be configured as described in any of paragraphs (CRM8) through (CRM10), wherein a first network connection between the first client device and the second client device is of higher quality than a second network connection between the first client device and the computing system, and wherein the first network connection is established using one or more application servers hosting the first and second applications.

(CRM12) At least one non-transitory computer-readable medium may be configured as described in any of paragraphs (CRM8) through (CRM11), wherein the downloaded file is stored in a memory of the second client device.

(CRM13) At least one non-transitory computer-readable medium may be configured as described in any of paragraphs (CRM8) through (CRM12), wherein the downloaded file is stored at an application server providing the second application to the second client device.

(CRM14) At least one non-transitory computer-readable medium may be configured as described in any of paragraphs (CRM8) through (CRM13), wherein the first client device is in communication with the computing system using a virtual private network (VPN) connection, and wherein the second client device is in direct communication with the computing system.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
receiving, by a first application executing on a first client device, a link to download a file from a computing system;
presenting, by the first application and via the first client device, a user interface element that, when selected, causes the first application to request a second application executing on a second client device to initiate a process for downloading the file from the computing system using the link;
in response to detecting selection of the user interface element, sending, by the first application, a request to the second application to initiate the process; and
receiving, by the first client device, the file that the second application caused download of from the computing system using the link.

2. The method of claim 1, wherein the first application and the second application are instances of a collaboration application that enables communication between a first user of the first client device and a second user of the second client device.

3. The method of claim 1, wherein a first network connection between the first client device and the second client device is of higher quality than a second network connection between the first client device and the computing system, and wherein the first network connection is established using one or more application servers hosting the first and second applications.

4. The method of claim 1, wherein the first client device is in communication with the computing system using a virtual private network (VPN) connection, and
wherein the second client device is in direct communication with the computing system.

5. The method of claim 1, further comprising:
receiving, by the first client device, a user input to download the file from the computing system; and
receiving, by the first client device and from the computing system, the link to download the file.

6. The method of claim 1, further comprising:
receiving, by the first application, an indication that the second client device is in direct communication with the computing system,
wherein the user interface element is presented by the first application in response to receiving the indication.

7. The method of claim 1, further comprising:
determining, by the first client device, a network connection quality for a connection between the first client device and the computing system,
wherein the first application presents the user interface element based at least in part on the network connection quality.

8. A method, comprising:
receiving, from a first application executing on a first client device and by a second application executing on a second client device, a link to download a file from a computing system;
causing, by the second application, the file to be downloaded from the computing system; and
causing, by the second application, the downloaded file to be sent to the first client device.

9. The method of claim 8, further comprising:
receiving, by the second client device and from the first client device, a request to download the file from the computing system; and
in response to receiving the request, presenting, by the second application, a user interface element that can be selected to confirm the second client device is to be used to download the file from the computing system,
wherein the second application is caused to use the link to download the file from the computing system in response to detecting, by the second application, selection of the user interface element.

10. The method of claim 8, wherein the first application and the second application are instances of a collaboration application that enables communication between a first user of the first client device and a second user of the second client device.

11. The method of claim 8, wherein a first network connection between the first client device and the second client device is of higher quality than a second network connection between the first client device and the computing system, and wherein the first network connection is established using one or more application servers hosting the first and second applications.

12. The method of claim 8, wherein the downloaded file is stored in a memory of the second client device.

13. The method of claim 8, wherein the downloaded file is stored at an application server providing the second application to the second client device.

14. The method of claim 8, wherein the first client device is in communication with the computing system using a virtual private network (VPN) connection, and
wherein the second client device is in direct communication with the computing system.

15. A first client device, comprising:
at least one processor; and
at least one computer-readable medium encoded with instructions which, when executed by the at least one processor, cause the first client device to:
receive, by a first application executing on the first client device, a link to download a file from a computing system;
present, by the first application, a user interface element that, when selected, causes the first application to request a second application executing on a second client device to initiate a process for downloading the file from the computing system using the link;
in response to detecting selection of the user interface element, send, by the first application, a request to the second application to initiate the process; and
receive the file that the second application caused download of from the computing system using the link.

16. The first client device of claim 15, wherein the first application and the second application are instances of a collaboration application that enables communication between a first user of the first client device and a second user of the second client device.

17. The first client device of claim 15, wherein a first network connection between the first client device and the second client device is of higher quality than a second network connection between the first client device and the computing system, and wherein the first network connection is established using one or more application servers hosting the first and second applications.

18. The first client device of claim 15, wherein the first client device is in communication with the computing system using a virtual private network (VPN) connection, and
wherein the second client device is in direct communication with the computing system.

19. The first client device of claim 15, wherein the at least one computer-readable medium is further encoded with additional instructions which, when executed by the at least one processor, further cause the first client device to:
receive a user input to download the file from the computing system; and
receive, from the computing system, the link to download the file.

20. The first client device of claim 15, wherein the at least one computer-readable medium is further encoded with additional instructions which, when executed by the at least one processor, further cause the first client device to:
receive, by the first application, an indication that the second client device is in direct communication with the computing system,
wherein the user interface element is presented by the first application in response to receiving the indication.
